(19) United States
(12) Patent Application Publication
(10) Pub. No.: US 2014/0356738 A1
(43) Pub. Date: Dec. 4, 2014

(54) AMMONIA BASED SYSTEM TO PREPARE AND UTILIZE HYDROGEN TO PRODUCE ELECTRICITY

(71) Applicants: Jimmy Todd Bell, Kingston, TN (US); Marvin Jonathan Haire, Houston, TX (US); Raymond George Wymer, Oak Ridge, TN (US)

(72) Inventors: Jimmy Todd Bell, Kingston, TN (US); Marvin Jonathan Haire, Houston, TX (US); Raymond George Wymer, Oak Ridge, TN (US)

(21) Appl. No.: 14/182,670

(22) Filed: Feb. 18, 2014

Related U.S. Application Data
(60) Provisional application No. 61/956,069, filed on May 31, 2013.

(51) Int. Cl. H01M 8/06

(52) U.S. Cl. CPC H01M 8/0662
USPC 429/411; 422/109

(57) ABSTRACT

A unique process for producing electricity from ammonia by utilizing its hydrogen content as a fuel source. The system may be referred to herein for descriptive purposes as Ammonia/Hydrogen/Electricity Production, or AHEP. The novelty of the system disclosed herein as compared to other hydrogen based fuel systems is the unique assembly of the components outlined below to create a novel process and ability to produce electricity that can be utilized for both mobile and stationary purposes. Further, the system is capable of producing hydrogen on demand to be converted into electricity, thereby obviating the need for storing large amounts of explosive hydrogen.

### BACKGROUND

The coal economy gave way to the petroleum economy in the 1930s and 1940s. An alternative economy has been sought during the past 30 years because oil is of limited supply and produces greenhouse gas emissions. These greenhouse emissions and carbon dioxide released into the environment are very harmful to the atmosphere. Hydrogen is a favorable alternative to petroleum due to the fact that it is relatively free of insults to the atmosphere and surrounding environment. Important chemical reactions with hydrogen and ammonia are carbon free, and the supply of both is limitless as there are vast amounts of nitrogen (78% of air) and water (H₂O) present in the biosphere.

The hydrogen economy uses hydrogen in place of carbon-based energy sources. Hydrogen can be produced domestically from a variety of alternative energy sources, such as wind, solar, or nuclear power, and can be used in the generation of electricity without the production of greenhouse gases. Hydrogen can power vehicles in a fashion similar to current gasoline and diesel transportation fuels. The use of hydrogen as fuel in combustion engines is already being studied, and a few automotive manufacturers are undergoing development of vehicles powered by hydrogen. However, studies show that the hydrogen fuel only driving range of these vehicles is limited, likely due to the relatively small hydrogen storage capacity on-board the vehicles.

Perhaps the biggest obstacle to a hydrogen economy is the safe and efficient storage, transport, and handling of the hydrogen. Hydrogen at standard atmospheric conditions has an energy density of only 0.20 MJ/L. Therefore, hydrogen is typically compressed to a high pressure into a liquid at approximately −250° C., and an energy density of 9.98 MJ/L. The process of pressurization, pumping hydrogen gas through long pipelines, and maintaining cryogenically cooled storage vessels, is costly.

Motors using ammonia as a working fluid have been proposed and occasionally used. The Iowa Energy Center at Iowa State University has examined an ammonia economy and the use of ammonia as fuel for an internal combustion engine or fuel cell. Ammonia consists of one atom of nitrogen and three atoms of hydrogen, therefore no carbon emissions are given off when ammonia is combusted or used in a fuel cell, just like hydrogen. The typical products of ammonia combustion are water and nitrogen, although nitrogen oxides may also be formed. Since ammonia is one of the most widely produced chemicals in the world, a significant infrastructure, including widely distributed ammonia production plants, pipelines and large scale refrigerated storage and distribution facilities, already exists.

Liquid anhydrous ammonia, with an energy density of 13.77 MJ/L, is much easier and safer to store, transport, and handle at ambient temperature and much lower pressure conditions than hydrogen. Ammonia is significantly less costly to store, transport and handle than hydrogen gas. With over 100 years of industrial history in the production and handling of ammonia, there is a well-established infrastructure for ammonia storage and distribution. Ammonia is currently primarily used in the production of fertilizer and as a refrigerant. There is existing equipment that dissociates ammonia into hydrogen and nitrogen gas, and membranes that can separate hydrogen from gas mixtures are available for ultra-high pure hydrogen feed to fuel cells.

Dissociated ammonia is a dry, reducing, oxygen-free gas mixture with a composition of 75% hydrogen and 25% nitrogen, by volume. It is a strong reducing gas, has virtually no impurities and thus is capable of preventing oxidation of metals at elevated temperatures. It is used for heat treating (hardening) metals so dryness is important. Hydrogen can be separated from the ammonia dissociated gas into nitrogen and hydrogen. This mixture can be used as feed to polymer electrolyte membrane (PEM) fuel cells. So, ammonia can be used as a carrier for hydrogen fuel. Dissociated ammonia is obtained by cracking anhydrous ammonia vapor in a catalyst filled vessel maintained at a temperature from 500 to 1000° C. The use of different catalysts causes this wide range of reaction temperatures where conversion (ammonia decomposition) occurs. The source ammonia is stored as a pressurized liquid in a tank or cylinder. Ammonia is drawn from the tank that is supplied to the dissociator retort. U.S. Pat. No. 6,936,363 (Kordesch) describes a compact, lightweight, thermally efficient ammonia dissociator and is hereby incorporated by reference.

Most current ammonia dissociators are large, heavy, thermally inefficient and meant to supply large amounts of hydrogen and nitrogen gases. A typical size and weight of a commercial industrial dissociator is approximately 6×6×6 feet and weighs roughly 3 tons. Hydrogen may be the most valuable constituent of the N₂ and H₂ gas mixture and is used in large-scale industries such as metal refining. However, there are times and situations where a small source of dissociated ammonia is needed, e.g., in a mobile environment to provide portable source of electricity.

Fuel cell systems have been installed all over the world and have seemingly endless applications. Stationary fuel cells are used for commercial, industrial, and residential primary and backup power generation. Fuel cells are very useful as power sources in remote locations, such as spacecraft, remote weather stations, large parks, communications centers, rural locations including research stations, and in certain military applications. Since fuel cell systems do not store fuel in themselves, they rely on an external storage tank. This arrangement allows for successful application in large-scale energy storage, rural areas being one example. In addition, fuel cells are very energy efficient and much cleaner than traditional power generation systems, such as a coal power plant.

A fuel cell system running on hydrogen can be compact and lightweight, and have no major moving parts. Because fuel cells have few moving parts and do not involve combustion, they provide a very reliable source of energy. The portability of a fuel cell system allows for successful use for mobile purposes such as automobiles, buses, construction equipment, and more. Fuel cell powered vehicles produce virtually no emissions, can run significantly longer before needing refueling, and have a much longer lifetime.

Ammonia can be used as a source of hydrogen in a hydrogen fueled economy. Transporting and storing hydrogen in ammonia form is significantly less expensive than doing so with hydrogen. Equipment systems exist to dissociate ammonia into its hydrogen and nitrogen gas constituents. Also, technology exists for extracting hydrogen from nitrogen and hydrogen gas mixtures to give pure hydrogen feed material for its intended use. Thus, this novel assemblage of equipment systems is configured in a way to enable the widespread use of hydrogen as an energy source, e.g. to supply hydrogen as fuel for combustion engines, fuel cell electric vehicle, stationary fuel sources, fossil fuel hydro-cracking, metallurgy or for other uses of hydrogen, while at the same time avoiding the shortcomings of hydrogen.

The present invention relates to a process whereby hydrogen is derived from ammonia and utilized by a fuel cell to produce electricity to power a mobile system such as a vehicle, or a stationary system such as a generator. Additional aspects and advantages of the present invention will be set forth in part in the description which follows, and in part will be obvious from the description, or may be learned by practice of the invention.

### BRIEF DESCRIPTION OF THE DRAWINGS

These and other features, aspects, and advantages of the present invention will become better understood with regard to the following description, appended claims, and accompanying drawings where:

FIG. 1 is a diagrammatic view of an ammonia based system to prepare and utilize hydrogen to produce electricity; and

FIG. 2 is a side cross-sectional view of a dissociator for converting gaseous ammonia into hydrogen and nitrogen gases.

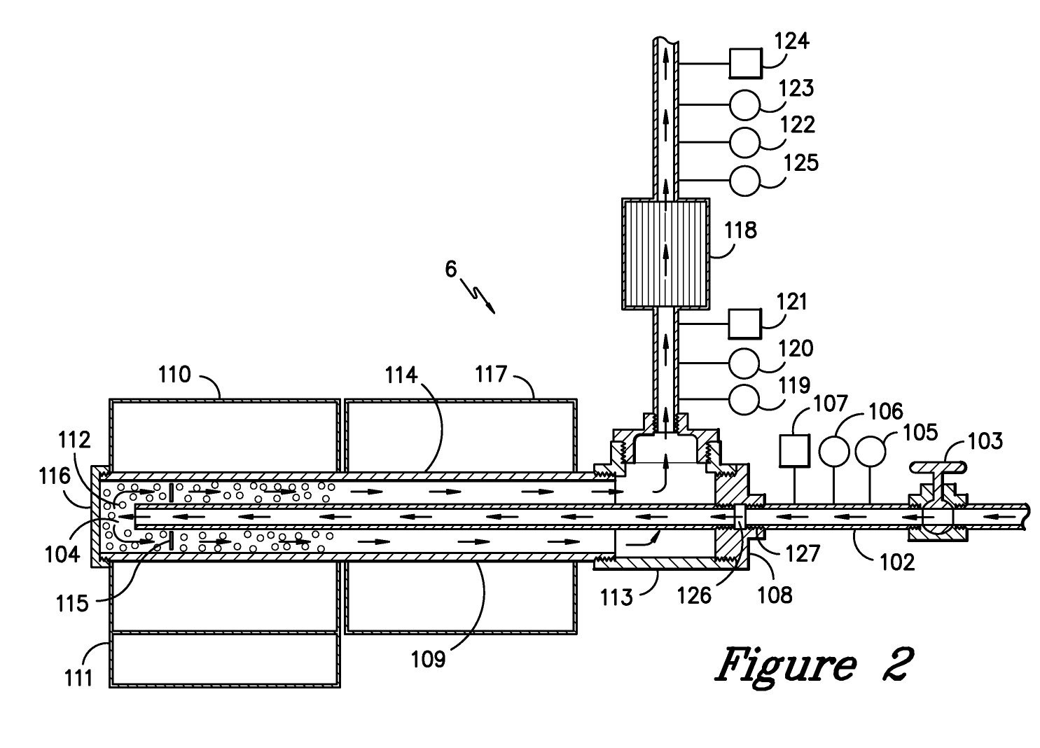

### SUMMARY OF THE INVENTION

The present invention includes a unique process for producing electricity from ammonia by utilizing its hydrogen content as a fuel source. The system may be referred to herein for descriptive purposes as Ammonia/Hydrogen/Electricity Production, or AHEP. The novelty of the system disclosed herein as compared to other hydrogen based fuel systems is the unique assembly of the components outlined below to create a novel process and total power delivery system that can be utilized for both mobile and stationary purposes. Industries such as the automotive, racing, shipping, and railway industries can utilize AHEP for powering cars, motorcycles, container trucks and ships, buses, boats, trains, and any other mobile vehicle. AHEP can also be used for stationary and interim energy supply purposes such as power plants, generators, and back-up or emergency generators.

This system could prove invaluable to a variety of sectors in the economy including private, industrial, leisure, and military.

The AHEP unit operates with four major functions:

1) ammonia storage and distribution wherein liquid ammonia is stored in a tank and then distributed by pump to the ammonia cracking equipment as needed;

2) the dissociation of ammonia (“cracking”) into hydrogen and nitrogen in the presence of a catalyst and high temperature of 500-700° C.;

3) a separation and purification process wherein hydrogen is separated with the desired purity from nitrogen and residual traces of ammonia using a membrane selective for the transmission of hydrogen; alternatively, this step may be avoided depending on the specific fuel cell used; and

4) production of electrical energy from the reaction of hydrogen with oxygen in a fuel cell to produce electrical energy and water.

Preferably, auxiliary equipment is used to support the four major functions. Such auxiliary supporting equipment may include pumps to provide pressure gradients necessary to move gases through equipment pieces, heat exchangers to capture heat for recycling to increase energy efficiency and control temperatures, valves to throttle gas flows to meet variable energy demands, electrical switches and controllers to provide electrical energy where needed, a high-energy or high capacity lithium ion battery to provide start-up energy for ammonia cracking, and electric motors. It is preferable to have dedicated computer(s) for control of power systems based on computer input from thermocouplings, flow meters, pressure sensors and other sensors.

Embodiments of the system may include features such as regenerative braking to convert braking energy to electrical energy, and a motor that cuts off when idling to save energy.

### DETAILED DESCRIPTION OF THE INVENTION

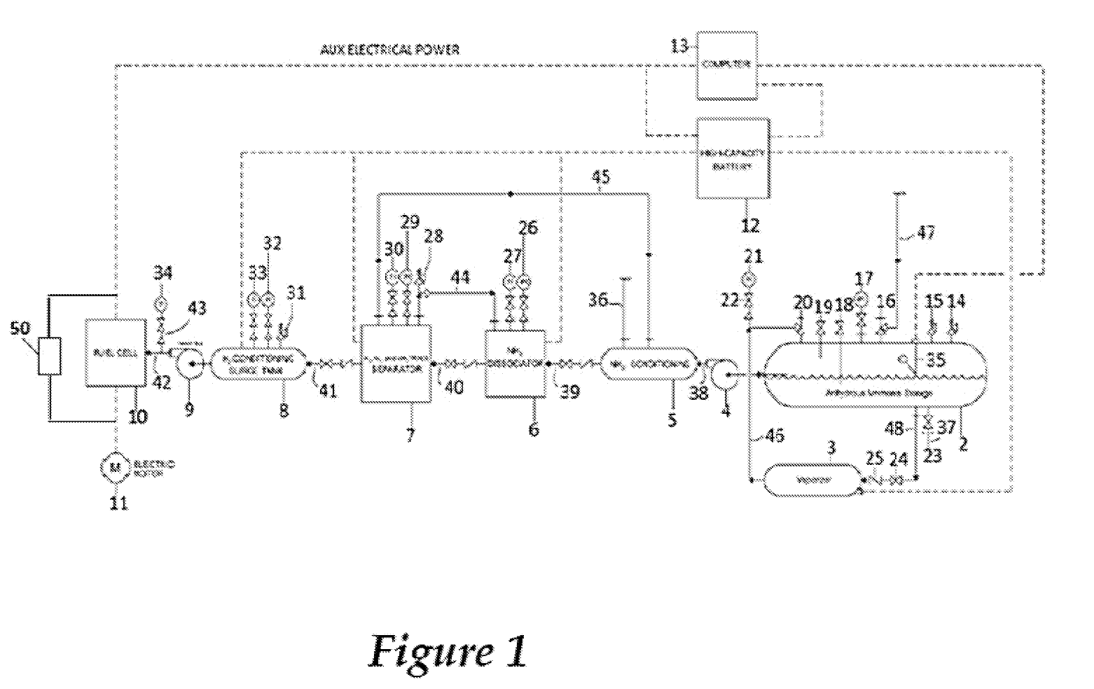

FIG. 1 shows a preferred embodiment, configuration, and relationship of key components of the AHEP system. The first component is an ammonia storage tank 2. Ammonia can be stored, for instance, as a liquid at an ambient temperature of 20° C. if pressure of 110 psig is maintained and the energy density of ammonia is at such a state of 13.77 MJ/L. By constructing the tank 2 with carbon steel, the storage pressure can be increased to 232 psig, thus keeping ammonia in a liquid state even if ambient temperature increases, although it is to be understood that other suitable materials may be used. During operation, heat created by the fuel cell 10 is preferably recycled back to the storage tank 2 to maintain the required temperature and pressure of the ammonia. An electrically heated vaporizer 3 connected to the tank 2 vaporizes the liquid ammonia, and the ammonia vapor is subsequently pumped through an ammonia conditioner 5 into a dissociator 6 where the ammonia molecule is cracked, i.e. broken, into hydrogen and nitrogen gas molecules. The dissociator 6 preferably operates at a temperature of 500-700° C., thus requiring electricity from a power source, which is preferably a high capacity battery 12 to provide heat during start-up. The gas mixture is fed from the dissociator 8 via an inlet line 40 to a hydrogen separation unit (referred to as “separator”) 7, operating at 300 to 450° C., where hydrogen is removed from the gas mixture. Hot nitrogen gas is used to preheat the ammonia feed, and then is vented; any un-reacted ammonia is preferably recycled from the separator 9 to the dissociator 8 by way of a connected recycling line 44. The hydrogen, at the exit temperature, is fed from the separator 7 via a connecting inlet line 41 to a hydrogen conditioner 8. The hydrogen conditioner 8 adjusts the hydrogen gas to the temperature and pressure required for feed for use dependent upon the requirements of the specific fuel cell selected. The hydrogen conditioner 8 preferably includes a connected pump/throttle 9 through which the conditioned hydrogen is passed to the fuel cell 10 for use. FIG. 1 shows the end use as a fuel cell 10 for production of electricity. The high-capacity battery 12 is connected via an electrical cable to the vaporizer 5, dissociator 6, separator 7, and hydrogen conditioner 8. The battery 12 provides electrical power to various pumps, valves, instrumentation, and throughout the AHEP system as needed. The battery 12 may also provide energy for system startup.

AHEP can operate with any of several types of fuel cell, each of which has certain advantages and disadvantages. The oxide fuel cell is well suited to AHEP because it operates at relatively high temperatures that are compatible with the hot hydrogen and nitrogen gases exiting the ammonia cracker, obviating the need for cooling the gases. In addition, the oxide fuel cell tolerates most minor impurities in the hydrogen and oxygen (air) reactant gases. However, the oxide fuel cell uses a potassium hydroxide (KOH) electrolyte that will react with the carbon dioxide present in air leading to fouling of the fuel cell due to precipitation of potassium carbonate (K2CO3). This problem can be circumvented by removal of carbon dioxide from the air prior to its introduction to the fuel cell. Carbon dioxide removal may be easily accomplished by adsorption on any of several commercially available molecular sieves. The relatively low concentration of carbon dioxide in air results in a long, useful lifetime before the molecular sieve requires regeneration. Regeneration and recycle of the molecular sieve back into service is readily achieved through heating to expel the adsorbed carbon dioxide. A carbon dioxide sensor on the exit air stream may be used to determine when carbon dioxide is no longer being effectively removed.

Ammonia Storage: A well-established industry exists for pipeline and truck transport, and for storage of anhydrous ammonia. Typically, the storage tank 2 contains about 85% liquid ammonia with the remainder of the tank 2 volume being ammonia vapor Anhydrous ammonia is optimally stored in a tank 2 at 325 psig and 60° C. Care must be taken to avoid moisture contacting ammonia because it becomes ammonia hydroxide, which is corrosive to iron or steel and is an irritant to the human tissue in varying degrees depending upon concentration and exposure. Ammonia is classified by the US Department of Transportation as a nonflammable gas. Conditions favorable to ignition are seldom encountered in normal handling due to its narrow range of susceptibility to ignition. Energy produced by the fuel cell 10 creates heat that can be recycled back to the ammonia tank 4 via a heat exchanger. This recycled heat may be used to warm the liquid ammonia to operating temperature, should ambient temperature drop.

Ammonia Vaporizer: Vaporization of the liquid ammonia may be performed by an ammonia vaporizer 3. A line connects the ammonia storage tank 2 to the ammonia vaporizer 3 whereby liquid ammonia is transported from the tank 2 to the vaporizer 3. The resulting gaseous ammonia is pumped from the vaporizer 3 through the ammonia conditioner 5 to the ammonia dissociator 6 via a line and pump similar to a fuel injection pump. The ammonia vaporizer 3 also maintains approximately constant storage tank pressure by increasing liquid ammonia temperature.

Ammonia Conditioner: The ammonia conditioner 5 is a heat exchanger and pressure adjustment system that preferably includes a flow control mechanism that controls the amount of ammonia that flows to the dissociator 6. Ammonia is pumped from the storage tank 2 through a connected pump 4 and inlet line 38 to the conditioner 5. The conditioner 5 includes a pressure pump and heat exchanger to adjust the temperature and pressure of the ammonia fed to the dissociator 6. Exhaust gas from the dissociator 6 may be used to preheat the ammonia.

Ammonia Dissociator: Anhydrous ammonia vapor is taken from the ammonia conditioner 5 via a connected line 39 and fed to a dissociator 6 where the ammonia is “cracked” to produce a 25% nitrogen and 75% hydrogen gas mixture by volume. Ammonia begins to dissociate at 500° C. Operating at 1000° C. ensures virtually complete dissociation. The dissociator 6 preferably includes a temperature indicator 27 and pressure indicator 26.

In one embodiment, the ammonia dissociator includes concentric pipes with a pre-heating and retort chamber. The inner tube takes anhydrous ammonia from storage to a furnace in a pipe where it then enters the annulus to counter-flow back through the furnace into an insulated region, thereby pre-heating the inflowing ammonia to the furnace. This arrangement greatly improves thermal efficiency. A fixed bed catalyst of, wire mesh, sphere/bead, rings, saddle, etc. shape within the pipes in the furnace are is present to promote ammonia (NH₃) dissociation into H₂ and N₂ gases, at a lower temperature than would otherwise be possible. A cooling system lowers the exit gases temperature to the level specified by the consuming customer.

In one preferred embodiment, anhydrous ammonia gas enters the dissociator 6 from the storage tank through, for example, a ¾ inch diameter stainless steel Schedule 316 inlet pipe 102 (herein referred to as inlet pipe 102) by opening a valve 103. An ammonia temperature sensor 105, ammonia pressure sensor 106 and ammonia flow rate sensor 107 take measurements to establish the ammonia inlet conditions to the dissociator 6. This inlet pipe 102 preferably includes longer than usual threads 127 (˜2 in) which enables the inlet pipe 102 to be threaded through the inside of a bushing 108, the bushing preferably 2 to ¾ inches. A threaded portion 127 of the inlet pipe 102 extends through the bushing 108. The longer than usual thread enables a coupling 126 to be screwed onto the inlet pipe 102 after it passes through the bushing 108. An inner open-ended pipe 109 continues the flow of ammonia into the dissociator 6. In a preferred embodiment, the inner open-ended pipe 109 is approximately 2 feet 2 inches long and ¾ inch diameter. The ammonia (NH₃) is heated by a furnace 110 and its controller 111 to a temperature that causes dissociation into nitrogen (N₂) and hydrogen (H₂) gas. A catalyst 112 lowers the temperature at which ammonia “cracking” occurs. The bushing 108 is threaded onto a tee 113. In a preferred embodiment, a 2 foot 4 inch outer pipe 114 (herein referred to as outer pipe 114) is screwed onto the other end of the tee 113. Stand-off pegs 115 keep the inner open-ended pipe 109 centered inside an outer pipe 114. Catalysts 112 are added to the furnace region 110. A cap 116 is secured onto the outer pipe 114 through welding or other similar suitable means. As ammonia flows from storage into the furnace 110, it faces the cap end 116 of the outer pipe 114. The ammonia flow makes a 180 degree turn and then flows countercurrent to the incoming flow in the inner pipe 109 in the annular pipe region 104. The NH₃ is dissociated/cracked into a mixture of N₂ and H₂ gases in the furnace region 110. The countercurrent flow through the insulated region 117 pre-heats ammonia flowing in the inner pipe 109 towards the furnace 110. The furnace temperature is maintained at a setting by a controller 111. The N₂ and H₂ gas makes a 90 degree turn in the tee 113 and flows toward a heat exchanger 118; a temperature sensor 119, pressure sensor 120, and flow rate sensor 121 measure temperature, pressure, and flow rate at the outlet of the tee 113 before entering the heat exchanger 118. The heat exchanger 118 lowers the N₂ and H₂ gas mixture temperature to the level required by follow-on equipment and customer. The fraction of ammonia converted to N2 and H2 is measured by a gas chromatograph 125 or other suitable sensor. Nitrogen and hydrogen gas temperature, pressure, and flow rate are measured by a temperature sensor 122, pressure sensor 123, and flow rate sensor 124 as they exit the heat exchanger 118.

A catalyst 112 is used to lower the temperature at which the ammonia is cracked. The catalyst 112 is placed in the furnace 110 in both the inner pipe 109 and annular region 104. The catalyst 112 is held in place by coarse stainless steel wool or another suitable material. Catalysts tested included nickel, rhodium or ruthenium electro-plated onto stainless steel turnings.

Another embodiment of the invention is to use a honeycomb gas heating element instead of a tube furnace. A tube furnace requires a relatively long time to reach equilibrium temperatures because of the mass involved in heating pipes which in turn heats the gases.

All metal that comes into contact with ammonia, hydrogen, and/or nitrogen are preferably made from Schedule 40, 316 stainless steel, or another suitable substitute. In a preferred embodiment, thread sealer may be used on threaded joints, for example, La-Co Slic-Tite Pipe Thread Sealer, along with a pipe thread lubricant and sealer, such as Teflon Tape.

Separator: The output from the ammonia dissociator 6 is a mixture of hydrogen, nitrogen and a small amount of ammonia. This mixture of hydrogen, nitrogen, and “uncracked” ammonia is fed from the dissociator 6 to the separator 7 via a connected line 40. The “uncracked” ammonia is recycled to the dissociator 6 using a pump and recycle line 44. Input and output hydrogen pressure is maintained by a pressure relief valve 28 and pressure indicator with isolation valve 29 contained on the separation unit 7. The purpose of a separator is to provide adequately pure hydrogen. Currently, a palladium-silver hydrogen purifier is the preferred hydrogen separation system. Existing thin film (3-9 μm thickness on a porous ceramic support tube) palladium membranes equipment extracts hydrogen from any reformed fuel with very high efficiency. The palladium alloy possesses the unique property of allowing only monoatomic hydrogen to pass through its crystal lattice when it is heated above 300° C. The palladium acts as a selective barrier, passing only atomic hydrogen through the layer, excluding other gases. Molecular hydrogen is adsorbed onto the surface where it dissociates to become atomic hydrogen. The hydrogen atom diffuses though the layer in the direction determined by the pressure gradient. The hydrogen atom recombines with another hydrogen atom on the low pressure side and is desorbed as a hydrogen gas molecule. The operating temperature is monitored by a temperature indicator with isolation valve 30 connected to the separator 7. Optimal operating temperature of a palladium separation system is about 300-450° C., resulting in hydrogen with a purity of from 99.5 to 99.995% that can be delivered to the fuel cell 10. Additionally, the separator may be made of an inorganic material that can operate under temperatures ranging from 500-1000° C., comparable to the operating temperature of the dissociator.

Hydrogen Conditioner: Hydrogen is fed from the separator 7 to the conditioner 8 via a connected line 41. The hydrogen conditioner 8 preferably includes a connected pressure relief valve 31, pressure indicator with isolation valve 32, and temperature indicator with isolation valve 33. The hydrogen conditioner 8 adjusts the temperature and pressure of the hydrogen as feed for its intended use as necessitated by the specific fuel cell being used. For example, as stated above, the separator 7 operates at a temperature of 300-450° C., whereas a proton electrolyte membrane fuel cell operates at 65° C. On the other hand, a solid oxide fuel cell operates at temperatures ranging from 500-1000° C. The temperature of the hydrogen feed must be adjusted accordingly. The hydrogen conditioner 8 also serves as a surge/interim storage tank for hydrogen. Heat required for start-up of the AHEP system is provided by the battery 12. Note that electricity must be provided to the other system components including the vaporizer 3, dissociator 6, separator 7, and miscellaneous pumps, valves, and instrumentation, in addition to the fuel cell's primary function of providing load electricity once operation is established.

Fuel Cell and Electric Motor: Whichever fuel cell type is used, the hydrogen conditioning tank 8 shown in FIG. 1 adjusts the hydrogen feed to the conditions required by the fuel cell 10. A pump/throttle system 9 connected to the hydrogen conditioner 8 feeds hydrogen through an inlet line 42 to the fuel cell 10. The inlet line 42 to the fuel cell 10 includes a line 43 running to a connected temperature indicator 34. The fuel cell 10 creates a direct current, which may be converted to an alternating current by an inverter 50. In the case of a mobile source of energy, such as an automobile, this current from the fuel cell 10 is fed to an electric motor 11. There are a variety of types of fuel cells with vastly different operation conditions. For example, a proton electrolyte membrane (PEM) fuel cell has a maximum fuel cell stack temperature of 65° C. In a 5 kW fuel cell a 99.999% dry hydrogen feed at 87-130 psig hydrogen pressure and at a maximum hydrogen flow rate of 80 l/min may be needed. A solid oxide fuel cell (SOFC) on the other hand operates at temperatures from 500-1,000° C.

Battery: In one preferred embodiment, a high capacity battery 12 is connected to the vaporizer 3, dissociator 6, separator 8, and hydrogen conditioner 8 via an electric cable provided in the event that not enough hydrogen is available in the hydrogen conditioner 8 for full start-up of the system. Electricity can also be provided from off-site, or from a different power source, for initial start-up. The battery 12 distributes electricity throughout the system and instrumentation as needed. In some applications a current inverter may be used to convert DC current to AC current.

Computer: It is desirable to control many of the subsystems of AHEP through a combination of distributed simple computer controls and a master computer control center 13 designed to actuate the distributed computer system upon input from the AHEP operator. Each major component may include a computer or computer chip to provide internal, individual process control. These distributed computers communicate with the central computer 13. Individual computers may include programmable logic controllers (PLC), programmable integral derivative controllers (PID), and other like devices. These computers monitor system instrumentation and, in turn, prompt commands and control actions. Control loops, including sensor control algorithms and actuators, are preferably arranged in such a fashion as to regulate a variable at a set point. For example, additional power may be supplied to the dissociator when a measured temperature in the dissociator drops below operational temperature. Automatic controls may trigger a series of mechanical actuators in the correct sequence to perform a task, such as turn valves, pumps, and electrical switches on and off

Auxiliary Equipment: Pumps may be provided for both liquid and gaseous ammonia flow at controlled rates to meet requirements by equipment operator-imposed power demands. Additionally, the hydrogen separator 7 and the fuel cell 10 both require pressure gradients to move hydrogen through them. The pressure gradients are dictated by operator-imposed power demands. For optimum energy efficiency it is desirable to recycle hot gases through heat exchangers to recover heat energy. Hot gases may be pumped to achieve and maintain AHEP efficiency. In all cases the pumps are preferably capable of providing controlled variable flow rates and pressures required to meet operator-imposed power demands.

Temperatures vary widely among the various equipment pieces during AHEP operation. For example, ammonia may be stored at a temperature of 60° C. while the ammonia dissociator 6, the next piece of equipment in the sequence, may operate with ammonia in the 500 to 700° C. range. To prevent loss of heat energy and consequent loss of AHEP efficiency it is desirable to recover the energy contained in the hydrogen and nitrogen gases between these temperature extremes. This energy recovery may be accomplished using heat exchangers of fairly simple design.

Flow rates of fluids from the pumps may be regulated to meet the operator-imposed power demands through a combination of metering valves and flow limiters controlled by a computer. In some cases the fluid to be controlled is liquid ammonia (e.g., ammonia feed to the dissociator 6); in others it is hydrogen/nitrogen gas mixtures (e.g., gaseous products from the dissociator 6); in still others it is hydrogen gas (e.g., product of the separator 7). Control of the metering valves is dictated by operator-imposed power demands. Flow limiters may be used to prevent over-supply of fluids. Flow limiters reduce the sophistication of equipment required for the control valves.

Preferably, the liquid ammonia in storage is heated to 500 to 700° C. in the dissociator 6 to dissociate the ammonia into hydrogen and nitrogen gases. The dissociator 6 may be electrically heated. The temperature may be controlled using a temperature regulator in conjunction with control valves. Pre-heating liquid ammonia prior to entering the dissociator 6 may be accomplished using a heat exchanger and hot gases recycled from the dissociator 6. Optimally, the system controls the temperatures of the gases leaving the dissociator 6 and entering both the hydrogen separator 7 and the fuel cell 10 to prevent damage to these components.

Electrically operated pumps, battery charger, and control valves include on/off switches that operate according to pre-determined voltage and current limitations. Voltage regulators may be used to charge and prevent over charging the battery 12 and to provide the necessary voltages to operate the electrical equipment such as pumps.

During start-up of the AHEP unit there is no electrical energy available from the fuel cell 10 to heat the dissociator 6, operate the pumps to provide pressure gradients or to provide electricity for operating gauges such as the ammonia fuel tank gauge, temperature gauges and any other necessary instrumentation. Substantial energy is needed to rapidly heat the dissociator 6 and operate the pumps prior to the time the fuel cell begins providing electrical power adequate to meet the needs. A high capacity battery 12 may be used to meet the initial power demands. Once the fuel cell 10 is operating, electrical demands are met by electricity produced by the fuel cell. The battery 12 may be charged as needed by the fuel cell 10.

As the present apparatus and method allows for various changes and numerous embodiments, particular embodiments will be illustrated in drawings and described in detail in the written description. However, this description is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used herein are merely used to describe particular embodiments, and are not intended to limit the scope of the present invention. An expression used in the singular encompasses the expression of the plural, unless it has a clearly different meaning in the context. It is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined herein.

When an element is mentioned to be “connected to” or “accessing” another element, this may mean that it is directly formed on or stacked on the other element, but it is to be understood that another element may exist in-between. On the other hand, when an element is mentioned to be “directly connected to” or “directly accessing” another element, it is to be understood that there are no other elements in-between.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

We claim:

1. Apparatus for converting ammonia into electrical energy, the apparatus comprising:
a storage tank for storing ammonia in liquid form;
a vaporizer operatively connected to said storage tank, wherein said vaporizer receives ammonia from said storage tank and converting said ammonia from liquid form to gas form;
an ammonia conditioner operatively connected to said vaporizer, wherein said ammonia conditioner receives said ammonia in gas form and regulates temperature, pressure and flow of said ammonia gas;
an ammonia dissociator operatively connected to said ammonia conditioner, wherein said ammonia dissociator receives said ammonia gas from said ammonia conditioner and converts said ammonia gas into a mixture of hydrogen, nitrogen and ammonia gases at temperatures ranging from about 500° C. to about 1000° C.;
a separator operatively connected to said ammonia dissociator, wherein said separator receives said mixture of hydrogen nitrogen and ammonia gases from said ammonia dissociator and returns said ammonia gas to said ammonia dissociator, while simultaneously separating said hydrogen gas from said nitrogen gas and venting said nitrogen gas out of said separator;
a hydrogen conditioner operatively connected to said separator, wherein said hydrogen conditioner receives said hydrogen gas from said separator , and wherein said hydrogen conditioner controls temperature and pressure of said hydrogen gas therein; and
a fuel cell operatively connected to said hydrogen conditioner, wherein said fuel cell receives said hydrogen gas from said hydrogen conditioner and produces an electrical current.

2. The apparatus set forth in claim 1, wherein said ammonia conditioner includes a flow control mechanism that controls the amount of ammonia that flows to said dissociator.

3. The apparatus set forth in claim 1, wherein exhaust gas from said dissociator is used to preheat said ammonia in said ammonia conditioner.

4. The apparatus set forth in claim 1, further including a pump and recycle line extending between said separator and said dissociator for transporting said ammonia gas from said dissociator to said separator.

5. The apparatus set forth in claim 1, wherein said separator includes a palladium-silver hydrogen purifier for separating said hydrogen gas from said nitrogen gas and said ammonia gas.

6. The apparatus set forth in claim 1, wherein said separator is made of inorganic material capable of operating under temperatures greater than 500° C.

7. The apparatus set forth in claim 1, wherein said hydrogen conditioner further includes a pressure relief valve, a pressure indicator with isolation valve, and a temperature indicator with isolation valve for monitoring and adjusting said temperature and pressure of said hydrogen gas.

8. The apparatus set forth in claim 1, further including an electric motor operatively connected to said fuel cell, wherein said electric motor is powered by said electric current generated by said fuel cell.

9. The apparatus set forth in claim 1, further including a power source operatively connected to said vaporizer, said ammonia dissociator, said separator and said hydrogen conditioner.

10. The apparatus set forth in claim 9, wherein said power source is selected from the group consisting of a battery, a fuel cell, and AC power plug.

11. The apparatus set forth in claim 9, wherein said fuel cell is electrically connected to said vaporizer, said ammonia dissociator, said separator, and said hydrogen conditioner, so that said fuel cell may also provide electrical current thereto.

12. The apparatus set forth in claim 1, further including an inverter operatively connected to said fuel cell for converting DC electricity to AC electricity.

13. The apparatus set forth in claim 1, wherein said fuel cell is a polymer electrolyte membrane fuel cell.

14. A method for generating electricity, said method comprising:
providing an amount of ammonia in liquid form;
vaporizing said liquid ammonia into ammonia gas;
heating said ammonia gas to a temperature range of between about 500° C. and about 1000° C.;
dissociating ammonia gas into hydrogen gas and nitrogen gas;
separating said nitrogen gas from said hydrogen gas;
feeding said hydrogen gas into a fuel cell;
combusting said hydrogen gas within said fuel cell to generate an electrical current.

15. The method set forth in claim 14, wherein said step of dissociating said ammonia gas into said hydrogen and nitrogen gas includes the steps of using a film of palladium silver to allow monoatomic hydrogen to pass through, while excluding other gases.

16. The method set forth in claim 14, further including the step of using a catalyst during said dissociation step in order to lower dissociation temperature.

17. The method set forth in claim 14, wherein said fuel cell is a polymer electrolyte membrane fuel cell.

18. The method set forth in claim 14, including the step of using said nitrogen in a heated state to provide heat to said dissociator.

19. A dissociator used for converting ammonia gas into hydrogen and nitrogen gas, said dissociator comprising:
a first tube concentrically and centrally positioned within a second, outer tube, said first tube adapted to receive a flow of ammonia gas from a first end thereof, and positioned so that said ammonia gas may pass from a second end of said first tube into said second, outer tube;
insulation wrapped around a first outer portion of said second outer tube, and a heating element positioned about a second outer portion of said second outer tube for heating said outer tube;
a temperature controller operatively connected to said tube furnace for controlling temperature of said heating element;
a catalyst positioned within said first and second tubes;
a third tube operatively connected to said second tube, and
a heat exchanger operatively connected to said third tube;
wherein said ammonia gas flows inwardly through said first tube, then flowing in an opposed direction through said second outer tube and through said fixed bed catalyst, and wherein said ammonia gas is dissociated into hydrogen and nitrogen gas prior to passing into said third tube.

20. The dissociator set forth in claim 19, wherein said heating element is selected from the group consisting of a tube furnace and a honeycomb gas heating element.

21. The dissociator set forth in claim 19, wherein said third tube is positioned at about a 90° angle with respect to said second outer tube.

22. The dissociator set forth in claim 19, wherein said catalyst is a fixed bed catalyst.

23. The dissociator set forth in claim 22, wherein said fixed bed catalyst includes material selected from the group consisting of nickel, rhodium and ruthenium.
